(19) United States
(12) Patent Application Publication
(10) Pub. No.: US 2012/0228923 A1
(43) Pub. Date: Sep. 13, 2012

(54) TWO-DIRECTION HUB ASSEMBLY

(75) Inventor: PI-YUN CHIANG, TAICHUNG HSIEN (TW)

(73) Assignee: JOY INDUSTRIAL CO., LTD., TAICHUNG HSIEN (TW)

(21) Appl. No.: 13/041,497

(22) Filed: Mar. 7, 2011

(51) Int. Cl. F16D 41/30; B60B 27/04; B60B 27/02

(52) U.S. Cl. 301/110.5

(57) ABSTRACT

A hub assembly includes a hub and an axle extending through the hub. A ratchet ring is located in the hub and has multiple ratchet teeth in an inside thereof. A transmission unit has a ratchet part located in the ratchet ring and the ratchet part has at least one transmission recess and at least one positioning recess defined in an outside thereof. The at least one transmission recess and the at least one positioning recess respectively have a transmission piece and a positioning pieces rotatably received therein. The transmission piece has a driving end engaged with one of the ratchet teeth. A resilient ring restricts the transmission piece and the positioning piece on the ratchet part. By the switch the transmission piece and the positioning piece, the transmission direction can be changed.

### FIELD OF THE INVENTION

The present invention relates to a hub assembly, and more particularly, to a hub assembly having a ratchet mechanism and can output work in either of two directions as needed.

### BACKGROUND OF THE INVENTION

A conventional hub assembly is connected with the axle of the wheel of bicycles and the ratchet mechanism for the hub assembly outputs work when the axle is rotated in one direction. In other words, when the pedals of the bicycle are treaded in one direction, the wheel is driven to move the bicycle forward and when the pedals are not rotated, the mechanism is not in function while the wheel continuously rotates.

The conventional ratchet mechanism for bicycles generally includes multiple pawls on the ratchet member and a ring with multiple toothed recesses. The conventional transmission modes include one-direction transmission and two-direction transmission, wherein the one-direction transmission can output work when the ratchet mechanism is operated in and the two-direction transmission can output work in both of two directions.

The chain of the bicycle usually is installed to the right side of the bicycle so that the transmission direction of the ratchet mechanism has to be the same as the direction that the bicycle moves forward, the direction is the same direction that the cyclist treads the pedals. However, in some cases or for some special bicycles, the chain is installed to the left side of the bicycle. Therefore, two-direction ratchet mechanism is developed to meet the requirement.

The one-direction bicycle hub assembly is disclosed in Taiwan Patent Application No. 095137512 and comprises a passive unit, a clutch unit and a driving unit, wherein the passive unit comprises a passive member which is rotatably about an axis and has multiple positioning recesses and resistance recesses defined in the outside thereof. The clutch unit comprises multiple pawls received in the restriction recesses and each pawl has a pivotable portion which is pivotably connected to the positioning recess. Each pivotable portion includes an engaging portion extending therefrom. A resilient member applies an outward force to the engaging portion in the positioning recess. Each resistance recess includes a resistance member received therein. The driving unit comprises ratchet wheel rotatably connected to the passive member and multiple ratchet teeth defined in an inside of the ratchet wheel. Each ratchet tooth has a push surface for pushing the engaging portion to drive the passive member, a pressing surface for pushing the engaging portion toward the positioning recess, and a tip which is connected between the pushing surface and the pressing surface and is in contact with the resistance member.

Taiwan Utility model No. 97215248 discloses a hub assembly that comprises an axle unit which extends along an axis, a case rotatably supported by the axle unit and having an internal hole defined in inside thereof, multiple receiving recesses located corresponding to an end of the internal hole, each receiving recess defined by an inner end and two curved portions, the two curved portions are symmetrically in shape and inner diameter. A clutch unit includes ratchet ring mounted to the axle unit and located in the internal hole. Multiple pawls are received in the receiving recesses and located at outside of the ratchet ring. Multiple resilient members are located in the receiving recesses and urge the pawls to contact the ratchet ring. The ratchet ring has multiple ratchet teeth and each ratchet tooth includes a first surface and a second surface which is located in opposite to the first surface. Each pawl has a pivotable end which is pivotably connected to one of the first and second curved portions, an engaging portion located in opposite to the pivotable end and engaged with the ratchet tooth, and a mediate portion located between the pivotable end and the engaging portion. The engaging portion is engaged with one of the first and second surfaces so as to be engaged with the ratchet teeth. The resilient member each has a curved part which is connected to one of the first curved portion and the second curved portion. A positioning portion is connected to a side of the curved part and positioned on the inner end of the receiving recess and includes a contact portion which is located on the other side of the curved part and contacts the mediate portion of the pawl. A chainwheel seat is connected to the case by the clutch unit.

When the pedal system is stopped, the resistance member of the first prior art is disengaged from the tip by the initial force of the rear wheel to drive passive unit relative to the driving unit to increase the safety. The second prior art can achieve the purpose of driving in two directions by switching the position of the pawl and resilient member.

For the second prior art, each positioning recess has a pair of pawl and resilient member which urges the pawl to contact the ratchet teeth. However, resilient member is so small and the number of the resilient members is matched with the number of the pawls, so that the significant number of small parts becomes a maintenance problem. When one of the resilient members is missing, the pawl corresponding thereto cannot contact the ratchet tooth and drives the ratchet tooth. Furthermore, the loosened pawl generates noise. The whole ratchet mechanism has to be replaced. It is obvious that the resilient member is the key part.

### SUMMARY OF THE INVENTION

The present invention relates to a hub assembly and comprises a hub with an axle extending therethrough and a ratchet ring is located in the hub with multiple ratchet teeth defined in an inside thereof. Two sides of each ratchet tooth are a first surface and a second side. A transmission unit has a ratchet part located in the ratchet ring and the ratchet part has at least one transmission recess and at least one positioning recess defined in an outside thereof The at least one transmission recess has a transmission piece rotatably received therein and the transmission piece has a driving end engaged with one of the ratchet teeth. The at least one positioning recess has a positioning piece rotatably received therein. A resilient ring restricts the transmission piece and the positioning piece on the ratchet part.

The primary object of the present invention is to provide a hub assembly which is easily to change the transmission direction. A resilient ring restricts multiple positioning pieces and transmission pieces, and even if one pair of the positioning pieces and the transmission pieces are missing, the hub assembly is still in function.

Another object of the present invention is to provide a hub assembly wherein the ratchet part has multiple positioning recesses and transmission recesses, and multiple positioning pieces and transmission pieces are received in the positioning recesses and the transmission recesses. By switching the positioning pieces and transmission pieces, the transmission direction is changed.

Yet another object of the present invention is to provide a hub assembly wherein the positioning pieces and transmission pieces are restricted by a resilient ring and quickly returned so that the transmission is quickly and smoothly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hub assembly of the present invention;

FIG. 2 is an exploded view to show the hub assembly of the present invention;

FIG. 3 is an exploded view to show the transmission unit of the hub assembly of the present invention;

FIG. 4 is a cross sectional view of the hub assembly of the present invention;

FIG. 5 shows the operational status of the transmission pieces in the transmission recesses;

FIG. 6 shows another operational status of the transmission pieces in the transmission recesses;

FIG. 7 shows that the hub assembly is operated in one transmission direction, and

FIG. 8 shows that the hub assembly is operated in another transmission direction.

### DETAILED DESCRIPTION OF THE PREFERRED EMBODIMENT

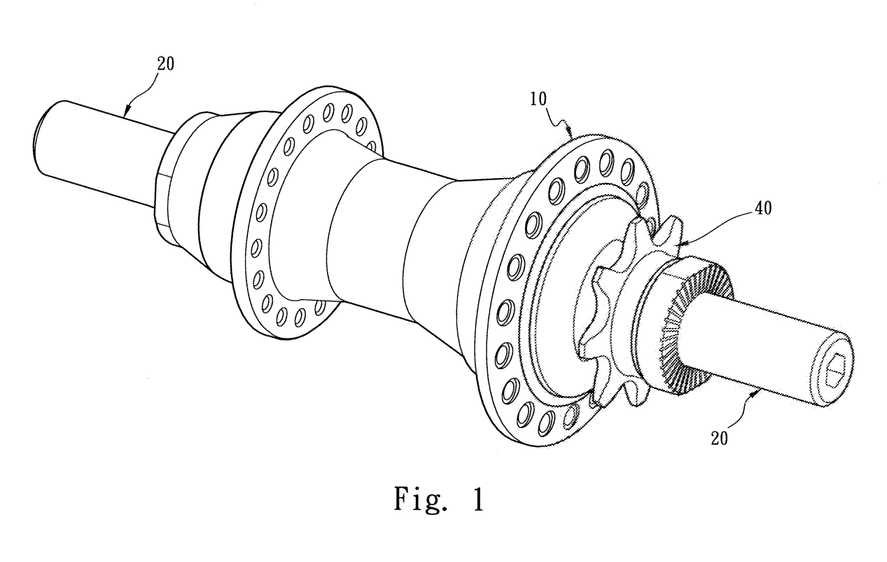

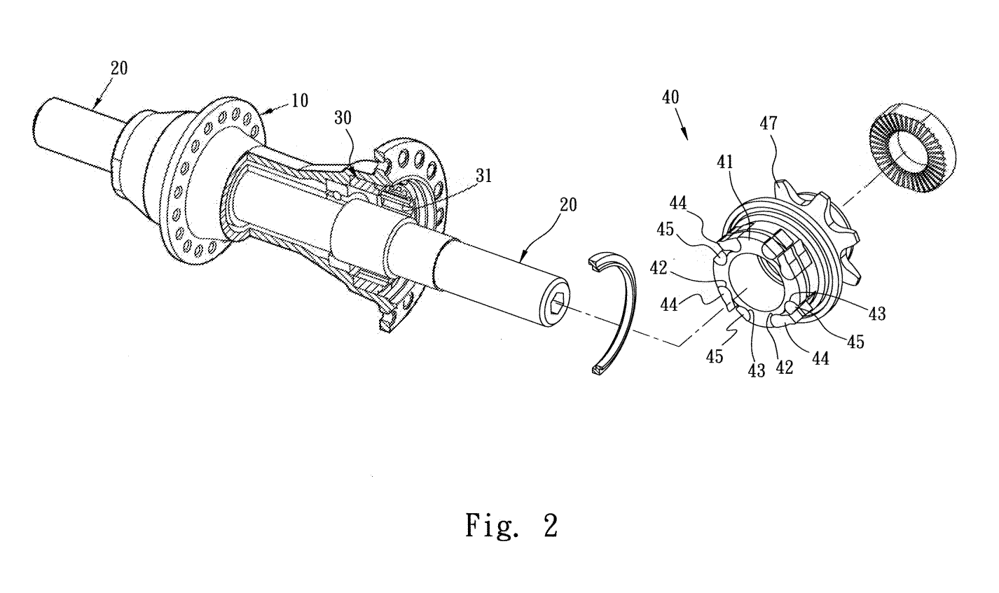

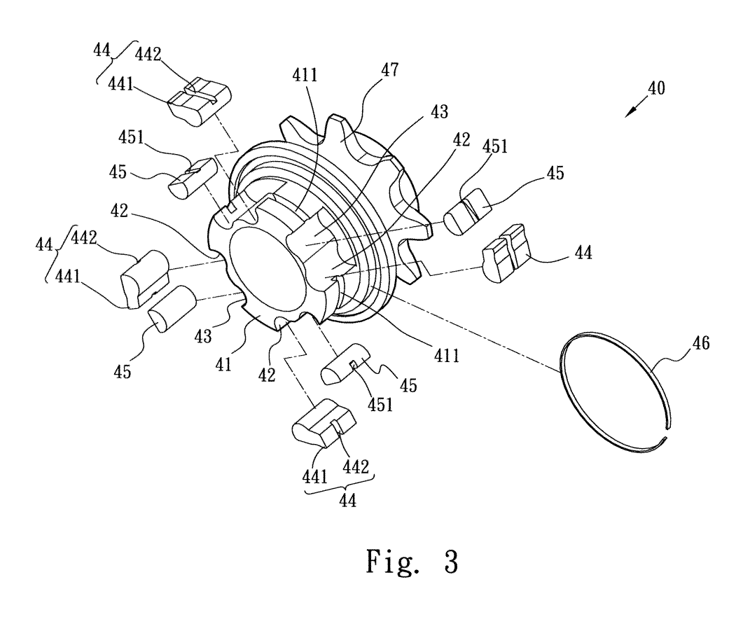

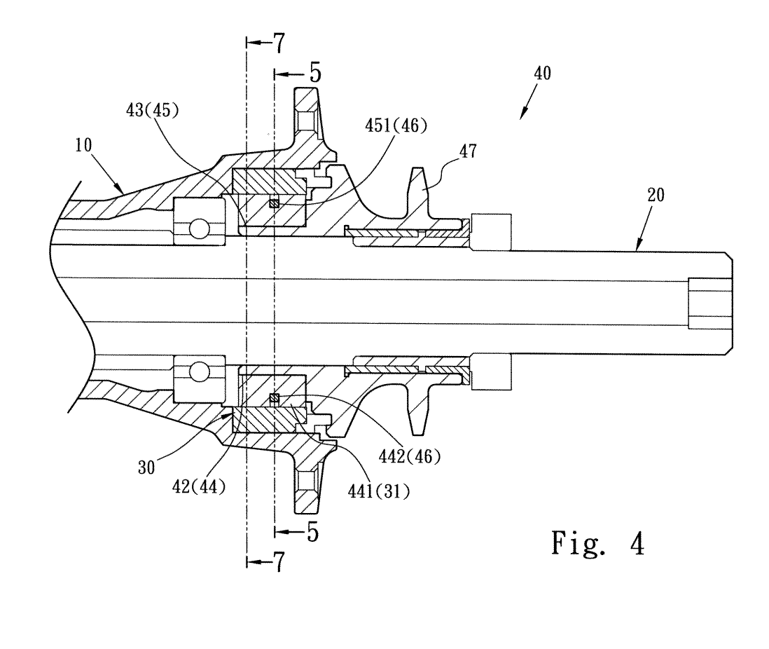

Referring to FIGS. 1 to 5, the hub assembly of the present invention comprises a hub 10, an axle 20 extending through the hub 10, a ratchet ring 30 and a transmission unit 40 cooperated with the ratchet ring 30.

The ratchet ring 30 is located in the hub 10 and multiple ratchet teeth 31 are defined in an inside thereof. Two sides of each ratchet tooth 31 are the first surface 311 and the second side 312.

The transmission unit 40 has a ratchet part 41 located in the ratchet ring 30 and the ratchet part 41 has four transmission recesses 42 and four positioning recesses 43 defined in the outside thereof The four transmission recesses 42 and the four positioning recesses 43 are located alternatively in pair. The four transmission recesses 42 each have a transmission piece 44 rotatably received therein and the transmission piece 44 has a driving end 441 engaged with one of the ratchet teeth 31. The driving end 411 is either in contact with the first surface 311 or the second surface 312 so as to transfer the force. The four positioning recesses 43 each have a positioning piece 45 rotatably received therein. A resilient ring 46 restricts the transmission pieces 44 and the positioning pieces 45 on the ratchet part 41. The ratchet part 41 includes a first groove 411 and the resilient ring 46 is engaged with the first groove 411. The transmission piece 44 includes a second groove 421 and the positioning piece 45 includes a third groove 451, the resilient ring 46 is engaged with the second and third grooves 421, 451.

The transmission unit comprises a driving gear 47 mounted to the axle 20 and co-axially connected to a side of the ratchet part 41. The ratchet part 41 is located between the ratchet ring 30 and the axle 20.

By switching the positioning pieces 45 and transmission pieces 44, the transmission direction is changed. Even if one pair of the positioning pieces 45 and the transmission pieces 44 are missing, the hub assembly is still in function.

When assembling, the ratchet ring 30 is connected between the hub 10 and the axle 20, and the ratchet ring 30 is located in the hub 10. The positioning pieces 45 and transmission pieces 44 are received in the positioning recesses 43 and the transmission recesses 42, and the resilient ring 46 restricts the positioning pieces 45 and transmission pieces 44 to the ratchet part 41 by engaging the first, second and third grooves 411, 442, 451. The positioning pieces 45 and transmission pieces 44 are engaged with the ratchet ring 30 and the driving ends 441 are engaged with the ratchet teeth 31.

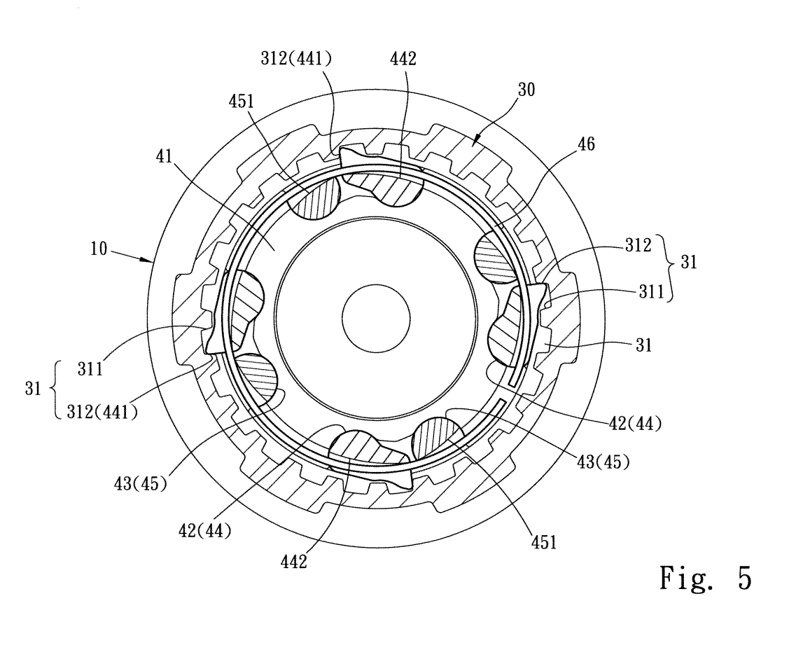

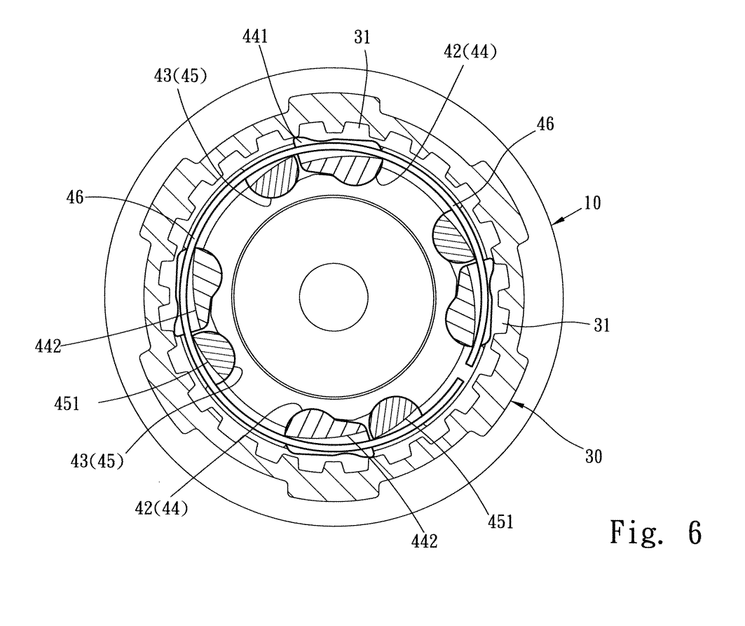

As shown in FIGS. 5 and 6, the resilient member 46 apply a force to the rotate the positioning pieces 45 in the positioning recesses 43 until a balance is reached. The transmission pieces 44 are rotated in the transmission recesses 42 by the resilient force until the driving ends 441 contact the second surfaces 312 so that the transmission unit 40 transfers force in the first direction.

When the transmission unit 40 is operated in the second direction or stops, the driving ends 441 are moved toward the ratchet teeth 31 and contact the protrusion portion of the ratchet teeth 31. When the transmission unit 40 continuously rotates, the transmission pieces 44 are rotated an angle by the resilient force of the resilient ring 46, the driving ends 441 are moved to be engaged with the recess between the ratchet teeth 31 to generate a “click” sound. The driving ends 441 reciprocally move up and down continuously and cannot output work.

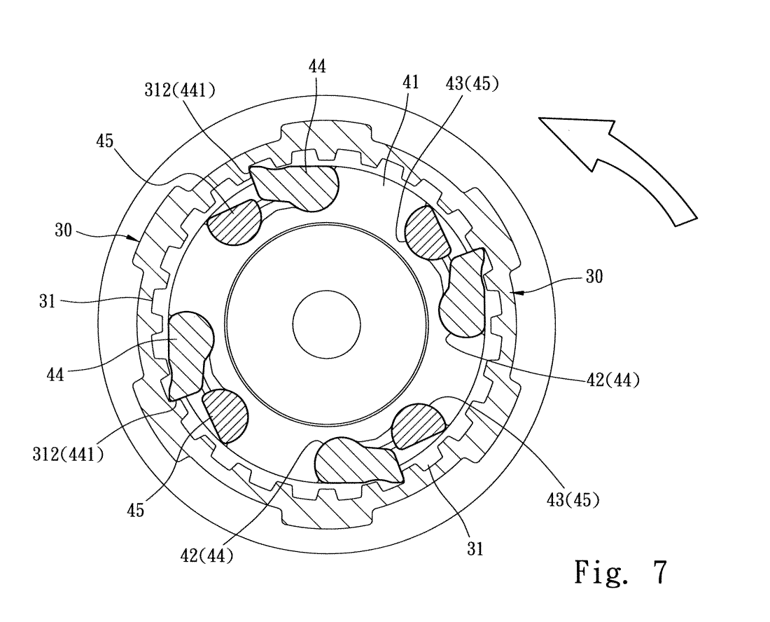

As shown in FIG. 7, if the transmission unit 40 is set to output work in the first direction, the four pairs of the transmission piece 44 and the positioning piece 45 are received alternatively in the transmission recesses 42 and the positioning recesses 43 of the ratchet part 41 and are restricted by the resilient ring 46. The transmission pieces 44 are rotated by the resilient ring 46 to let the driving ends 441 be engaged with the second surfaces 312. When the driving gear 47 is rotated in the first direction by the chain, the transmission piece 44 and the positioning piece 45 are rotated. The driving ends 441 push the second surfaces 312 to rotate the ratchet teeth 31 and the hub 10 in the first direction so that the wheel is rotated in the first direction.

When the chain is stopped, the driving gear 47, the ratchet part 41, the transmission pieces 44 and the positioning pieces 45 stop. However, the initial force continuously rotates the ratchet ring 30 and the hub 10. The driving ends 441 are moved over the ratchet teeth 31 to generate “click” sound, and the wheel still rotates.

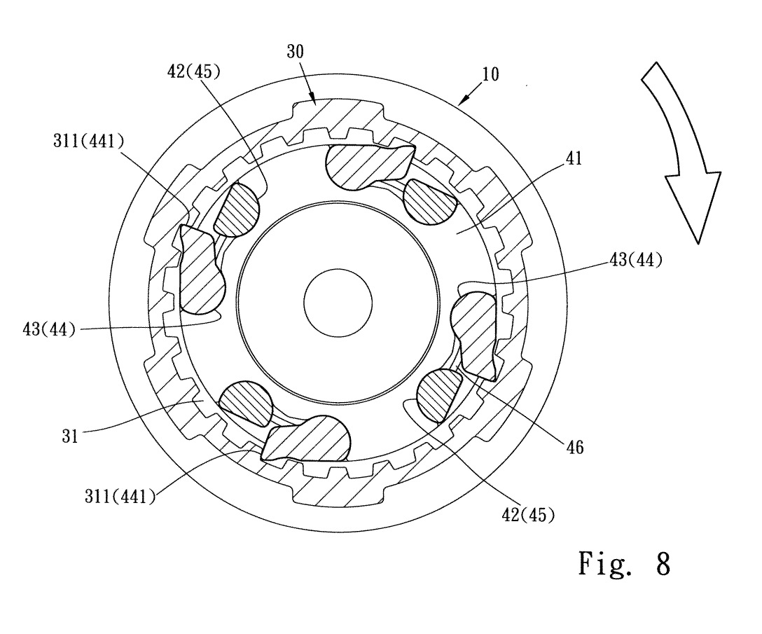

As shown in FIG. 8, if the transmission unit 40 is set to output work in the second direction, the four pairs of the positioning piece 45 and the transmission piece 44 are received alternatively in the transmission recesses 42 and the positioning recesses 43 of the ratchet part 41 and are restricted by the resilient ring 46 (the positions of the positioning piece 45 and the transmission piece 44 are switched relative to that disclosed in FIG. 7). The transmission pieces 44 are rotated by the resilient ring 46 to let the driving ends 441 be engaged with the first surfaces 311. In other words, the positioning pieces 45 are received in the transmission recesses 42 and the transmission pieces 44 are received in the positioning recesses 43 of the ratchet part 41.

When the driving gear 47 is rotated in the second direction by the chain, the transmission pieces 44 and the positioning pieces 45 are rotated. The driving ends 441 push the first surfaces 311 to rotate the ratchet teeth 31 and the hub 10 in the second direction so that the wheel is rotated in the second direction. When the chain is stopped, the initial force continuously rotates the ratchet ring 30 and the hub 10. The driving ends 441 are moved over the ratchet teeth 31 to generate “click” sound, and the wheel still rotates.

The present invention can change the transmission direction by switching the positions of the transmission pieces 44 and the positioning pieces 45, the driving ends 441 can be engaged with the first or second surfaces 311, 312 so that the users can install the hub assembly on either left or right side of the bicycle as needed. The structure is simple and easily assembled and can be manufactured at low cost.

The transmission pieces 44 and the positioning pieces 45 are restricted by the resilient ring 46, so that even if one pair of the transmission piece 44 and the positioning piece 45 are missing or lost, or one piece of the transmission pieces 44 or the positioning pieces 45 is missing, the rest of the transmission pieces 44 and the positioning pieces 45 are still in function to allow the wheel to rotate. Furthermore, the positioning pieces 45 keep the resilient ring 46 to a proper tension status so that the resilient ring 46 is expanded and restricted within a range and this makes the driving ends 441 to move on the ratchet teeth 311 quickly so that the transmission is more sensitive and smooth with less noise.

The first, second and third grooves 411, 442, 451 in the ratchet part 41, the transmission pieces 44 and the positioning pieces 45 provide the resilient ring 46 are firmly and reliable engagement so that the resilient ring 46 is well positioned and does not drop off.

While we have shown and described the embodiment in accordance with the present invention, it should be clear to those skilled in the art that further embodiments may be made without departing from the scope of the present invention.

What is claimed is:

1. A hub assembly comprising:
a hub;
an axle extending through the hub;
a ratchet ring located in the hub and multiple ratchet teeth defined in an inside thereof, two sides of each ratchet tooth being a first surface and a second side, and
a transmission unit having a ratchet part located in the ratchet ring and the ratchet part having at least one transmission recess and at least one positioning recess defined in an outside thereof, the at least one transmission recess having a transmission piece rotatably received therein and the transmission piece having a driving end engaged with one of the ratchet teeth, the at least one positioning recess having a positioning piece rotatably received therein, a resilient ring restricting the transmission piece and the positioning piece on the ratchet part.

2. The hub assembly as claimed in claim 1, wherein the ratchet part includes a first groove and the resilient ring is engaged with the first groove.

3. The hub assembly as claimed in claim 1, wherein the transmission piece includes a second groove and the positioning piece includes a third groove, the resilient ring is engaged with the second and third grooves.

4. The hub assembly as claimed in claim 1, wherein driving end is in contact with either the first surfaces or the second surfaces.

5. The hub assembly as claimed in claim 1, wherein the transmission unit comprises a driving gear mounted to the axle and co-axially connected to a side of the ratchet part, the ratchet part is located between the ratchet ring and the axle.

6. The hub assembly as claimed in claim 1, wherein the at least one transmission recess and the at least one positioning recess are alternatively located in an outside of the ratchet part.

7. The hub assembly as claimed in claim 1, wherein there are multiple transmission recesses and multiple positioning recesses alternatively located in an outside of the ratchet part, each of the transmission recesses has a transmission piece rotatably received therein and each of the positioning recesses has a positioning piece rotatably received therein, the resilient ring restricts the transmission pieces and the positioning pieces to the ratchet part.

8. The hub assembly as claimed in claim 7, wherein each of the ratchet parts includes a first groove and the resilient ring is engaged with the first groove, each of the transmission pieces includes a second groove and each of the positioning pieces includes a third groove, the resilient ring is engaged with the second and third grooves.
